(19) United States
(12) Patent Application Publication
(10) Pub. No.: US 2013/0287499 A1
(43) Pub. Date: Oct. 31, 2013

(54) Lifting Device for Drilling Riser

(71) Applicant: TAPER-LOK CORPORATION, Houston, TX (US)

(72) Inventors: Justin M. Fraczek, Spring, TX (US); Erik M. Howard, Baytown, TX (US); Randy D. Arthion, I, Spring, TX (US)

(73) Assignee: Taper-Lok Corporation, Houston, TX (US)

(21) Appl. No.: 13/869,828

(22) Filed: Apr. 24, 2013

Related U.S. Application Data
(60) Provisional application No. 61/638,319, filed on Apr. 25, 2012.

(51) Int. Cl. F16L 1/20

(52) U.S. Cl. CPC F16L 1/20
USPC 405/171; 405/173

(57) ABSTRACT

Systems for lifting drilling risers that serve as thrust collars to retain buoyancy modules on the risers and also enable the risers to be lifted using lifting lugs that are attached to the thrust collars. In one embodiment, a lifting device uses two annular ribs at the edges of a cylindrical collar, wherein the ribs have substantially constant height, but varying thickness. The thickness of each rib is greater at the position of the lifting lug, and may also be greater at its base than that its top or outermost edge. The collar may be segmented, where the segments are bolted together to assemble the device around the riser. The segments may be pre-stressed to reduce stresses during lifting. The device may include an elastomeric layer on its inner surface.

### CROSS-REFERENCE TO RELATED APPLICATIONS

This application claims the benefit of U.S. Provisional Patent Application 61/638,319 by Justin M. Fraczek, Erik M. Howard, and Randy D. Arthion for a Lifting Device for Drilling Riser, filed Apr. 25, 2012, which is incorporated by reference as if set forth herein in its entirety.

### BACKGROUND

1. Field of the Invention

The invention relates generally to oilfield equipment and more particularly to drilling risers and apparatus for lifting drilling risers.

2. Related Art

Subsea drilling operations (also referred to as offshore drilling operations) are often carried out to recover hydrocarbons (e.g., oil and gas) from geological formations that lie beneath the seabed. In these operations, a pipe is typically installed between a floating drilling platform and a wellhead at the seabed. This pipe consists of a series of pipe segments called drilling risers, which are connected end-to-end. Drilling mud that is pumped into the well through a drill pipe flows out of the well between the drill pipe and the drilling risers, carrying cuttings out of the well.

A typical drilling riser may be 90 feet long and weigh 20,000-50,000 pounds. The size and weight of the riser may cause difficulty in positioning and installing or removing the riser. Consequently, buoyancy modules are normally coupled to the drilling riser to increase its buoyancy and thereby facilitate handling of the riser underwater, although they complicate handling of the riser out of the water. The buoyancy modules are typically cylindrical units that are positioned around and secured to the drilling riser. Thrust collars are secured near each end of the riser to transfer the axial buoyancy load of the buoyancy modules to the riser. The thrust collars may include lifting lugs to which cables can be attached to allow the riser to be suspended for purposes of moving or positioning it.

Conventional thrust collars have a cylindrical ring portion and a rib which extends outward from the ring portion. The ring portion encircles the drilling riser and secures the thrust collar to the end of the riser. The thrust collar is positioned adjacent to a buoyancy module at one end of the drilling riser with the rib facing the buoyancy module. When the thrust collar is secured to the riser, the rib transfers the axial force from the buoyancy modules to the drilling riser.

In a conventional thrust collar that has a lifting lug so that it can be used as a lifting device, the lug is typically welded to the ring portion and to the rib. In some cases, the height of the rib is increased at the lifting lug to better distribute stresses when the riser is suspended by the lifting lug. One of the problems with conventional thrust collars, however, is that although conventional designs are very forgiving in regard to axial loads, they may be subject to very high bending stresses when the lifting lugs are used. Typically, conventional thrust collars cannot meet API-defined stress limits when the lifting lugs are used. It would therefore be desirable to provide improved lifting devices in which stresses are reduced, preferably to such a degree that the API-defined stress limits can be met, and preferably in a way that reduces the weight of the devices.

### SUMMARY OF THE INVENTION

This disclosure is directed to systems for lifting drilling risers that solve one or more of the problems discussed above. One particular embodiment comprises a lifting device for a drilling riser, where the device includes a collar and a lifting lug. The collar has a cylindrical ring with a first annular rib connected to a first circular edge of the ring and a second annular rib connected to a second circular edge of the ring. The lifting lug is connected to the collar between the first and second ribs. Each of the first and second ribs has an increased thickness at an angular position at which the rib is connected to the lifting lug. The thickness tapers down to a reduced thickness as the angular distance from the lifting lug increases. In one embodiment, the annular ribs may taper from a smaller thickness at a top edge of the rib to a greater thickness at a base of the rib. The thickness at the base of each annular rib may, for example, be at least half of a height of the annular rib. The inner surface of each rib (which faces the other rib) may have a minimum radius of curvature of at least half of a height of the rib.

In one embodiment, the collar has a plurality of segments that are coupled together to secure the device to the drilling riser. Each segment forms a portion of the cylindrical ring and the annular ribs. One embodiment has three segments that can be bolted together, while other embodiments may use hinges, clamps or other means (or combinations thereof) to couple together adjacent segments. Spherical washers and seats therefor may be employed to reduce bending stresses on the bolts when the segments are coupled together. An elastomeric layer may be provided on a cylindrical inner surface of the collar to cushion the collar against the drilling riser.

An alternative embodiment comprises a drilling riser assembly which includes a pipe section, one or more buoyancy modules and a pair of lifting devices. The buoyancy modules are annularly shaped and are positioned around the pipe section. The two lifting devices are secured to the ends of the pipe section to retain the buoyancy modules on the pipe section. Each of the lifting devices includes a collar and a lifting lug. The collar has a cylindrical ring with annular ribs connected to the circular edges of the ring. The lifting lug is connected to the collar between the first and second ribs. Each of the ribs has a greater thickness where the ribs are connected to the lifting lug. The thickness of the ribs tapers from this thickness to a reduced thickness as the angular distance from the lifting lug increases. The ribs may taper from a smaller thickness at a top edge of each rib to a greater thickness at a base of the rib. The thickness at the base of each annular rib may, for example, be at least half of a height of the annular rib. The inner surface of each rib may have a minimum radius of curvature of at least half of a height of the rib. The collar may be segmented, and the segments may be coupled together by bolts, hinges, clamps, other means or combinations thereof. The radius of curvature of an inner surface of each segment may be greater than a radius of curvature of the pipe section, so that each lifting device is pre-tensioned when installed on the pipe section. An elastomeric layer may be provided on a cylindrical inner surface of the collar to cushion the collar against the drilling riser.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating a conventional drilling riser suspended from a pair of cables

FIG. 2 is an illustration of a conventional thrust collar having a lifting lug.

FIG. 3 is a perspective view of an improved lifting device in accordance with one embodiment.

FIG. 4 is a plan view of the lifting device of FIG. 3 along a centerline of the device.

FIG. 5 is a side plan view of the lifting device of FIG. 3.

FIG. 6 is a diagram illustrating the profile of the cylindrical ring and ribs of the lifting device of FIG. 3.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF PREFERRED EMBODIMENTS

One or more embodiments of the invention are described below. It should be noted that these and any other embodiments described below are exemplary and are intended to be illustrative of the invention rather than limiting.

As described herein, various embodiments of the invention comprise improved lifting devices that may serve as thrust collars or lift slicks which are used with buoyancy modules on drilling risers and also enable the drilling risers to be lifted using lifting lugs that are attached to the thrust collars. The improved lifting devices incorporate features that reduce stresses when the lifting lugs are used to suspend the drilling riser to which the thrust collars are secured. The lifting devices use two annular ribs at the edges of a cylindrical collar, wherein the ribs have substantially constant height, but varying thickness. The thickness of each rib is greater at the position of the lifting lug, and may also be greater at its base than that its top or outermost edge. These features provide improved load transfer and reduce stresses in the lifting device, thereby decreasing the likelihood that the device will fail. These features may also enable reduction of the lifting device's weight and cost.

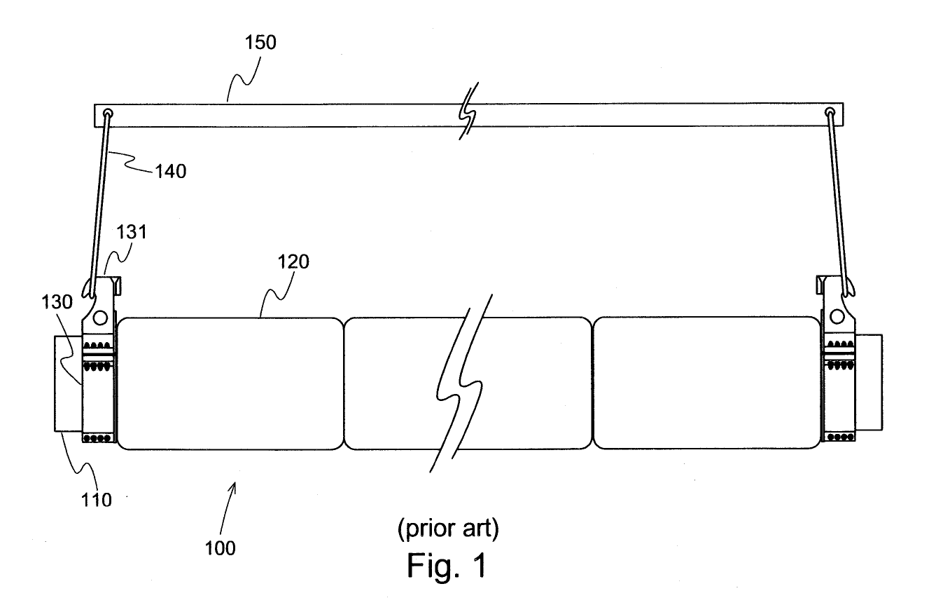

Referring to FIG. 1, a diagram illustrating a conventional drilling riser suspended from a pair of cables is shown. Drilling riser 100 includes a pipe section 110 that has a plurality of buoyancy modules 120 mounted on it. Each of the buoyancy modules is generally annular, having a cylindrical outer surface and a cylindrical aperture therethrough to allow the buoyancy module to be placed around the pipe section. A thrust collar (e.g., 130) is secured near each end of pipe section 110 to prevent the buoyancy modules from slipping off pipe section 110.

Each of the thrust collars (e.g., 130) has a lifting lug (e.g., 131) which extends outward from the collar to allow a cable (e.g., 140) to be attached to it. In this example, each of the cables is connected at its upper end to a lifting member 150. The purpose of the lifting member is to apply the lifting force of the cables attached to the two thrust collars perpendicularly to the axis of the riser, thereby minimizing the bending stresses that can be created by forces that are not perpendicularly applied. If a lifting member is not used, and the upper ends of the cables are attached to a single point, some of the lifting force applied to the lifting lugs will be directed toward the center of the riser, causing the thrust collars to undergo bending stresses.

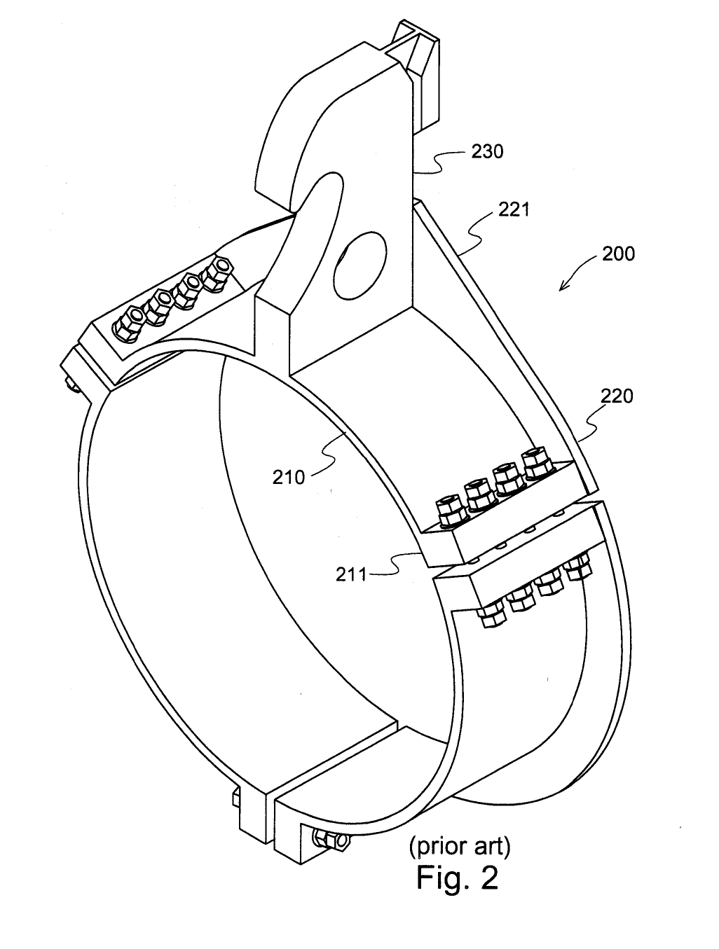

Referring to FIG. 2, an illustration of a conventional thrust collar having a lifting lug is shown. In this embodiment, it can be seen that thrust collar 200 includes a cylindrical ring portion 210, a rib 220 and a lifting lug 230. Rib 220 is welded to one of the circular edges of ring portion 210. Lifting lug 230 is welded to the outer surface of ring portion 210 and to rib 220. Thrust collar 200 is sectioned into three segments to facilitate installation and removal of the thrust collar on a drilling riser. Each of the segments has a flange portion (e.g., 211) at each end which allows it to be bolted to the adjacent segments.

In a conventional thrust collar that does not have a lifting lug, the rib at the edge of the cylindrical ring typically has a constant height (the distance from the cylindrical ring to the outermost or maximum-diameter edge of the rib). In the thrust collar depicted in FIG. 2, the height of the rib is extended near the lifting lug to facilitate load transfer from the lifting lug, through the rib, to portions of the cylindrical ring farther from the lifting lug. This extended portion of the rib (221) may be referred to as a “web”. Regardless of whether the rib is extended in this manner, the lifting force is not evenly transferred to both ends of the cylindrical ring, and the device is subject to bending stresses that often exceed API-specified limits.

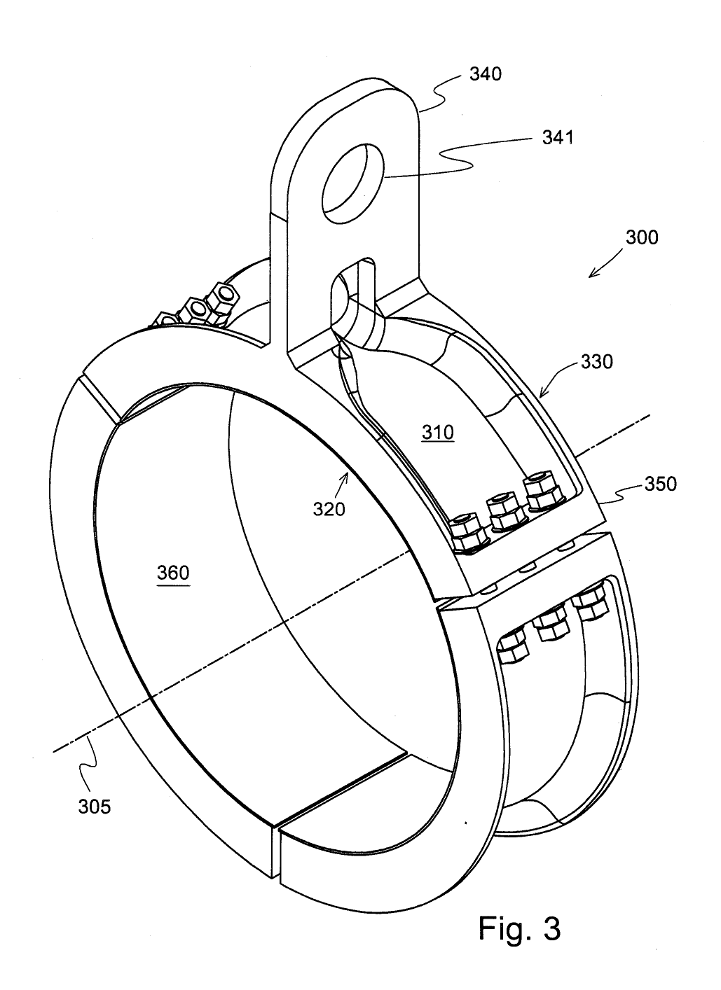

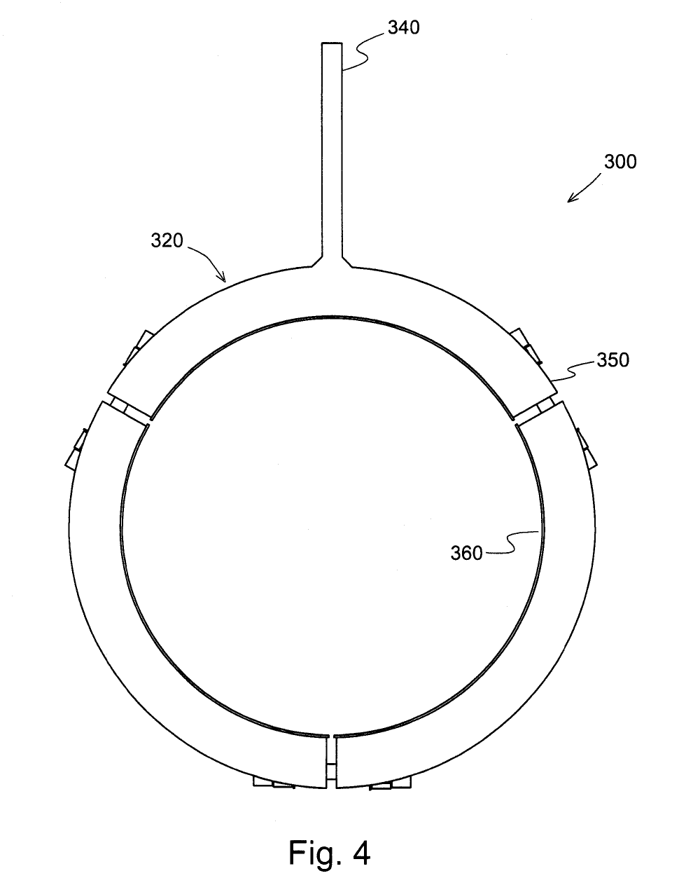

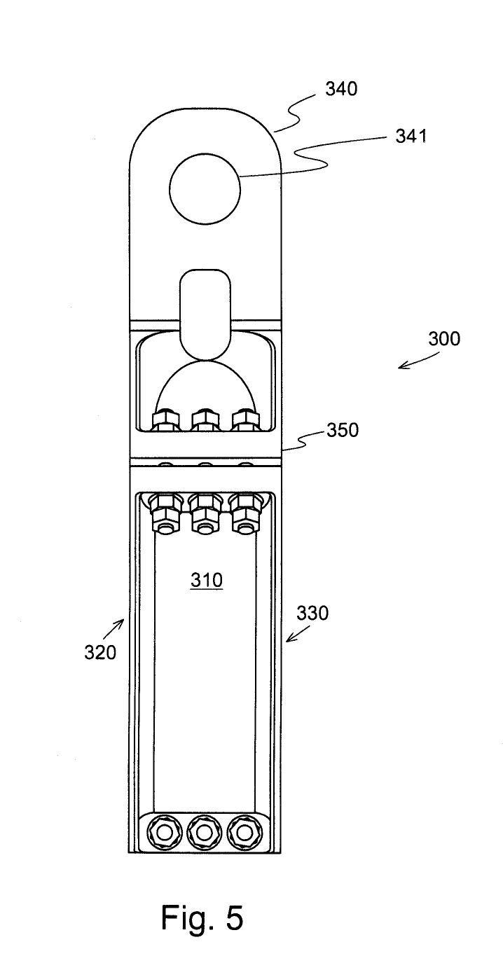

Referring to FIGS. 3-5, an exemplary embodiment of an improved lifting device incorporating a thrust collar and a lifting lug is shown. FIG. 3 is a perspective view of the improved lifting device, while FIGS. 4 and 5 are plan views of the device.

Lifting device 300 includes a cylindrical ring portion 310, a pair of generally annular ribs 320 and 330 and a lifting lug 340. Although lifting lug 340 is depicted in FIGS. 3 and 5 as having an eye 341 by which a cable can be attached to the lug, the lifting lugs in alternative embodiments may have hooks, as shown in the conventional device of FIG. 2, rather than eyes. Each of ribs 320 and 330 is joined to a corresponding one of the circular edges of cylindrical ring 310. Cylindrical ring portion 310 and annular ribs 320 and 330 are divided into three segments. One of the segments has lifting lug 340 connected to it and has variations in the thickness of ribs 320 and 330 as a function of angular position. The other two segments are identical to each other, and the ribs on these segments have constant thickness as a function of angular position. Each of the segments has two flanges (e.g., 350) that allow the segments to be bolted together to form the cylindrical ring portion and ribs. A layer of elastomeric material (e.g., 360) is provided on the inner surface of cylindrical ring 310 to prevent slippage and to provide some cushioning between the device and a drilling riser on which the device may be installed.

The use of two ribs—one joined to each circular edge of the cylindrical ring portion of the device—serves to strengthen the device against bending and the resulting stresses. Conventional thrust collars such as the one illustrated in FIG. 2 only have a single rib because the purpose of the rib is to retain the buoyancy modules on the drilling riser. When a lifting lug is added to the conventional thrust collar, the single rib is extended to form a web in order to more evenly distribute the lifting load across the rib, but no effort is made to address the bending stresses on the device.

It can also be seen, particularly in FIG. 3, that each of ribs has a greater thickness where it is joined to the lifting lug than over the remainder of the rib. For the purposes of this disclosure, the “thickness” or “width” of the rib is the dimension parallel to centerline 305 of the cylindrical ring, while the “height” of the rib is the dimension perpendicular to the centerline. The thickness of the ribs tapers to a smaller thickness as the angular distance from the lifting lug increases. As used herein, the “angular” distance or position is determined based on the centerline 305 of the lifting device. In the embodiments of FIGS. 3-5, this change in thickness as a function of angular position is confined to the segment that includes the lifting lug—the thickness of the ribs on the other two segments does not change as a function of angular position. It should be noted that the flanges (e.g., 350) at the end of each segment are not considered to be part of the ribs for determining the thickness of the ribs. It should also be noted that, although the thickness of the ribs changes in this embodiment as a function of height as well as angular position, the profile (the thickness as a function of height) does not change as a function of angular position, so this should not be construed as a change in thickness as a function of angular position.

The thickened portions of the ribs serve several purposes. For instance, because lifting lug 340 is joined to each rib at the thickened portion, the lifting load transferred from the lifting lug to the rib is more evenly distributed than in a conventional device, resulting in reduced stress risers (high localized stresses) that might otherwise cause the device to fail. The conventional thrust collar, by comparison, has very high stress risers at the welds between the lifting lug and the cylindrical ring and between the lifting lug and the rib. The thickened ribs in the embodiment of FIG. 3 also stiffen the device, so that bending stresses are reduced in comparison to a conventional thrust collar. Still further, since the thickened ribs provide better load transfer from the lifting lug to the ribs and cylindrical ring, it is not necessary to increase the height of the ribs at the lifting lug, so this device is not significantly heavier than a conventional thrust collar.

The thickening of the ribs near the lifting lug is a balance between two different types of designs that use ribs of different thicknesses. Taller, thinner ribs have a greater moment of area that makes them stiffer and results in less deflection. With less deflection, however, other components must compensate, thereby increasing stresses. Shorter, thicker ribs have a lower moment of area, allowing more flexibility, but providing a large cross section to take the loads on the device.

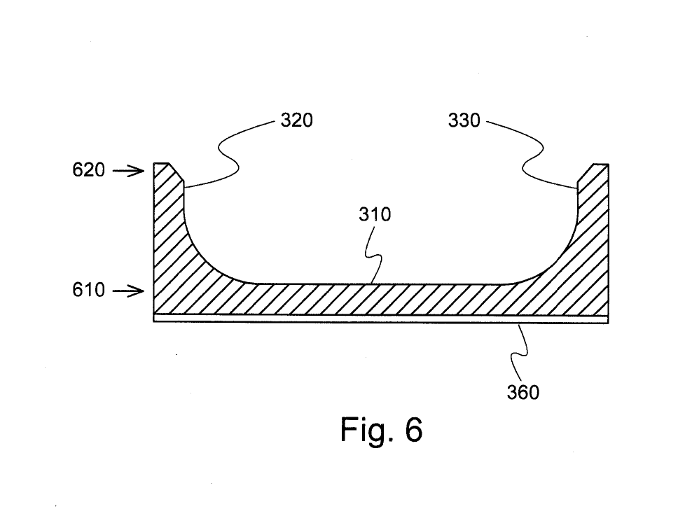

Another feature of the device shown in FIGS. 3-5 is the changing thickness of each rib as a function of the radial distance from centerline 305. This is shown in more detail in FIG. 6, which shows the profile of the cylindrical ring and ribs. The thickness of the rib changes from the base 610 at which the rib is joined to the cylindrical ring, to the top 620 of the rib (the edge farthest away from the centerline of the cylindrical ring). Each rib is relatively thin at its top, and the width tapers to a greater thickness at the base. As depicted in FIGS. 3, 5 and 6, the inner wall of the rib (the surface that that faces the other rib) is rounded, with a radius of curvature that is approximately the same as the height of the rib. In other embodiments, the inner wall may have different curvatures, but will preferably be a smooth curve, rather than having corners (such as in a welded joint) that will cause stress risers. The curve will preferably have a minimum radius of curvature of at least half of the height of the rib. The thickness at the base of the rib may also vary, but will preferably be at least half of the height of the rib.

In a preferred embodiment, the lifting device is forged and machined. In this embodiment, a forging for each segment is produced, and then the forging is machined to the specific dimensions of the segment. The forging causes the metallurgical grain structure of the metal to flow along the contours of the forging die, which strengthens the segment. The machining of the segment ensures that the dimensions of the segment can meet very strict tolerances that are very difficult to meet when welding different components together, as in the prior art. The additional strength may then allow the device to use less material, reducing its weight and cost.

As noted above, the lifting device is designed to be secured around a drilling riser. The “inner surface” of the lifting device is the cylindrical surface that faces the drilling riser. In a conventional thrust collar and lifting device, the inner surface of the device has a curvature that is the same as the drilling riser to which it will be secured. In one embodiment of the present lifting device, the curvature of the inner surface is slightly different than the curvature of the drilling riser. More specifically, the radius of curvature of the inner surface is greater than the radius of curvature of the riser. As a result, when the lifting device is installed, the midpoint of each segment of the lifting device contacts the drilling riser first, then as the segments are secured to each other, the remainder of the segments' inner surfaces are brought into contact with the drilling riser. It should be noted that the differing curvature of the lifting device's inner surface may, but does not necessarily, take into account the thickness of the layer of elastomeric material that may be applied to the inner surface.

As the bolts of the lifting device are preloaded and the geometry of the device deflects (e.g., as described above), the lifting device is pre-stressed. This is true whether the device has the specific curvature described above or not. If the lifting device is pre-stressed, the amount of alternating stress that is experienced by the device will be reduced. This reduction of alternating stresses increases the fatigue life of the device and may result in more evenly distributed stresses.

The embodiment of FIGS. 3-5 uses bolts to connect the adjacent segments of the lifting device. Bolt holes are provided in the flanges (e.g., 350) at the ends of each segment. A threaded bolt or stud is inserted through each of the bolt holes and is secured by nuts that are threaded onto the stud. Spherical washers are positioned between the nuts and the flanges, and spherical seats which are complementary to the washers are provided on the flanges. The spherical washers and seats allow the studs to pivot slightly with respect to the flanges. Consequently, the flexing of the segments and the resulting misalignment of the flanges with respect to each other does not place any bending stress on the studs which might cause them to fail. It should be noted that the bolt holes are slightly oversized with respect to the studs so that the studs can pivot slightly within the bolt holes.

It should also be noted that, in other embodiments, the segments can be coupled together by means other than bolts. For instance, in one embodiment, the segments may have flanges that are configured to be clamped together. In another embodiment, the segments may be coupled together by hinges.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A lifting device for a drilling riser, the device comprising:
a collar having a cylindrical ring, a first annular rib connected to a first circular edge of the ring and a second annular rib connected to a second circular edge of the ring; and
a lifting lug connected to the collar at the first and second ribs;
wherein for each of the first and second ribs, the rib has a first thickness at an angular position at which the rib is connected to the lifting lug and tapers to a reduced thickness as an angular distance from the lifting lug increases.

2. The lifting device of claim 1, wherein the cylindrical ring comprises a plurality of segments, wherein each of the segments is coupled to one or more adjoining ones of the segments.

3. The lifting device of claim 2, wherein the cylindrical ring comprises at least three of the segments.

4. The lifting device of claim 2, wherein each of the segments is configured to be bolted to the one or more adjoining ones of the segments.

5. The lifting device of claim 4, further comprising one or more spherical washers positioned between each of a plurality of bolts and a corresponding one of the segments, wherein a plurality of spherical seats for the spherical washers are provided on the segments.

6. The lifting device of claim 1, further comprising an elastomeric layer positioned against a cylindrical inner surface of the collar.

7. The lifting device of claim 1, wherein each of the first and second annular ribs tapers from a smaller thickness at a top edge to a greater thickness at a base of the annular rib.

8. The lifting device of claim 7, wherein the thickness at the base of each annular rib is at least half of a height of the annular rib.

9. The lifting device of claim 7, wherein for each rib, an inner surface that faces the other rib has a minimum radius of curvature of at least half of a height of the rib.

10. A drilling riser assembly comprising:
a pipe section;
one or more buoyancy modules, wherein each of the buoyancy modules is annular and is positioned around the pipe section; and
a pair of lifting devices, wherein a first one of the lifting devices is secured to a first end of the pipe section and a second one of the lifting devices is secured to a second end of the pipe section, thereby retaining the one or more buoyancy modules on the pipe section;
wherein each of the lifting devices includes a collar and a lifting lug, wherein the collar has a cylindrical ring, a first annular rib connected to a first circular edge of the ring and a second annular rib connected to a second circular edge of the ring, wherein the lifting lug is connected to the collar at the first and second ribs, and wherein for each of the first and second ribs, the rib has a first thickness at an angular position at which the rib is connected to the lifting lug and tapers to a reduced thickness as an angular distance from the lifting lug increases.

11. The drilling riser assembly of claim 10, wherein the cylindrical ring comprises a plurality of segments, wherein each of the segments is coupled to one or more adjoining ones of the segments.

12. The drilling riser assembly of claim 11, wherein the cylindrical ring comprises at least three of the segments.

13. The drilling riser assembly of claim 11, wherein each of the segments is configured to be bolted to the one or more adjoining ones of the segments.

14. The drilling riser assembly of claim 13, further comprising one or more spherical washers positioned between each of a plurality of bolts and a corresponding one of the segments, wherein a plurality of spherical seats for the spherical washers are provided on the segments.

15. The drilling riser assembly of claim 10, further comprising an elastomeric layer positioned against a cylindrical inner surface of the collar.

16. The drilling riser assembly of claim 10, wherein each of the first and second annular ribs tapers from a smaller thickness at a top edge to a greater thickness at a base of the annular rib.

17. The drilling riser assembly of claim 16, wherein the thickness at the base of each annular rib is at least half of a height of the annular rib.

18. The drilling riser assembly of claim 16, wherein for each rib, an inner surface that faces the other rib has a minimum radius of curvature of at least half of a height of the rib.

19. The drilling riser assembly of claim 10, wherein a radius of curvature of an inner surface of each lifting device is greater than a radius of curvature of the pipe section, and wherein each lifting device is pre-stressed when installed on the pipe section.
